(19) United States
(12) Patent Application Publication
(10) Pub. No.: US 2026/0230102 A1
(43) Pub. Date: Aug. 6, 2026

(54) TRANSCEIVER, COMMUNICATION SYSTEM, AND METHOD FOR ACTIVATING TRANSCEIVER

(71) Applicant: DENSO CORPORATION, Kariya-shi (JP)

(72) Inventors: Mao YAMAUCHI, Kariya-shi (JP); Yasuhiro KOTANI, Kariya-shi (JP)

(21) Appl. No.: 19/433,580

(22) Filed: Dec. 26, 2025

(30) Foreign Application Priority Data
Jan. 31, 2025 (JP) 2025-015177

(51) Int. Cl. H04B 1/40; H04W 52/02

(52) U.S. Cl. CPC H04B 1/40; H04W 52/0235

(57) ABSTRACT

A transceiver, which is included in a node, has at least one circuit. The at least one circuit includes an activation signal detection unit configured to detect identification information of an activation signa transmitted by another node to the on-board communication line. The node is connected to an on-board communication line as one of multiple nodes. Each of the multiple nodes is configured to transmit, to the on-board communication line, the activation signal that includes the identification information for identifying own node. The transceiver is configured to be activated when the identification information detected by the activation signal detection unit corresponds to own node.

### CROSS REFERENCE TO RELATED APPLICATION

The present application claims the benefit of priority from Japanese Patent Application No. 2025-015177 filed on January 31, 2025. The entire disclosure of the above application is incorporated herein by reference.

### TECHNICAL FIELD

The present disclosure relates to a technology for performing communication between nodes connected to an on-board communication line.

### BACKGROUND

Conventionally, an on-board system includes multiple on-board ECUs and on-board devices, which are connected to an on-board communication line. The multiple on-board ECUs are connected, using a bus, to an on-board communication line through a communication cutoff unit. The on-board device outputs a cutoff signal to a communication cutoff unit included in a target on-board ECU for which activation is not required. Thus, the target on-board ECU for which activation is not required is disconnected from the on-board communication line. Thereafter, the on-board device transmits an activation signal to the on-board ECU for activating the on-board ECU.

### SUMMARY

According to an aspect of the present disclosure, a transceiver included in a node is provided. The node is connected to an on-board communication line as one of multiple nodes. The transceiver includes at least one circuit, and the at least one circuit includes an activation signal detection unit. the activation signal detection unit may be configured to detect identification information of an activation signal, which is transmitted by another one of the multiple nodes to the on-board communication line. Each of the multiple nodes is configured to transmit, to the on-board communication line, the activation signal that includes the identification information for identifying own node. The transceiver may be configured to be activated when the identification information detected by the at least one circuit corresponds to own node.

### BRIEF DESCRIPTION OF DRAWINGS

Features of the present disclosure will become apparent from the following detailed description made with reference to the accompanying drawings. In the drawings:

FIG. 1 is a diagram showing an exemplary configuration of a communication system according to an embodiment of the present disclosure;

FIG. 2 is a diagram showing a configuration of an ECU included in the communication system according to an embodiment;

FIG. 3 is a block diagram showing a first example of a functional configuration of a transceiver according to an embodiment;

FIG. 4 is a block diagram showing a second example of a functional configuration of a transceiver according to an embodiment;

FIG. 5 is a block diagram showing a third example of a functional configuration of a transceiver according to an embodiment;

FIG. 6 is a block diagram showing another example of an activation control unit of the transceiver according to an embodiment;

FIG. 7 is a diagram showing an example of a table stored in a storage unit of a transceiver according to an embodiment;

FIG. 8A to FIG. 8E are diagrams showing activation signals according to different embodiments; and

FIG. 9 is a diagram showing switching of states in controllers and transceivers of the first ECU and second ECU when the first ECU is activated and then the first ECU activates the second ECU according to an embodiment.

### DETAILED DESCRIPTION

As described above, an on-board system includes multiple on-board ECUs and on-board devices, which are connected to an on-board communication line. The multiple on-board ECUs are connected, using a bus, to an on-board communication line through a communication cutoff unit. The on-board device outputs a cutoff signal to a communication cutoff unit included in a target on-board ECU for which activation is not required. Thus, the target on-board ECU for which activation is not required is disconnected from the on-board communication line. Thereafter, the on-board device transmits an activation signal to the on-board ECU for activating the on-board ECU. With this configuration, the on-board ECU for which activation is not required is maintained in deactivated state. Thus, the on-board system can reduce consumption power by keeping the on-board ECU for which activation is not required in the deactivated state.

In the above-described on-board system, only the on-board device can disconnect the on-board ECU for which activation is not required from the on-board communication line. Therefore, each of the multiple on-board ECUs cannot be individually started in response to an activation request transmitted from another on-board ECU.

According to an aspect of the present disclosure, a transceiver included in a node is provided. The node is connected to an on-board communication line as one of multiple nodes. The transceiver includes an activation signal detection unit configured to detect identification information of an activation signal, which is transmitted by another one of the multiple nodes to the on-board communication line. Each of the multiple nodes is configured to transmit, to the on-board communication line, the activation signal that includes the identification information for identifying own node. The transceiver is configured to be activated when the identification information detected by the activation signal detection unit corresponds to own node.

In the above configuration, the transceiver receives the activation signal, which is transmitted by another node to the on-board communication line. The transceiver then detects the identification information included in the received activation signal, and is activated when the detected identification information corresponds to own node. A node other than the activation target is also connected to the on-board communication line and receives the activation signal. But a node other than the activation target is not activated because the identification information does not correspond to own node. Therefore, the transceiver can be individually activated in response to an activation request from another node connected to the on-board communication line.

According to another aspect of the present disclosure, a communication system includes a first communication device and a second communication device, which are connected to an on-board ethernet communication line as multiple nodes. The first communication device includes an activation signal detection unit configured to detect identification information of an activation signal received from the on-board ethernet communication line. Each of the multiple nodes is configured to transmit, to the on-board ethernet communication line, the activation signal that includes the identification information for identifying own node. The first communication device is configured to be activated when the detected identification information corresponds to the first communication device and then transmit a notification indicating activation of the first communication device to the second communication device. The second communication device is configured to be activated when an activation message is received from the on-board ethernet communication line after receiving, from the first communication device, the notification indicating activation of the first communication device.

With the above configuration, the second communication device can be activated in response to reception of the activation message after the first communication device is activated.

According to another aspect of the present disclosure, a method for activating a transceiver is provided. The transceiver is connected to an on-board communication line. The method includes: receiving an activation signal from the on-board communication line, the activation signal having identification information for identifying one of multiple nodes connected to the on-board communication line; detecting the identification information of the received activation signal; and activating the transceiver in response to the detected identification information corresponding to own node.

The activation method provides the same effects as the above-described transceiver.

### Embodiments

### 1. Configuration of on-board communication system

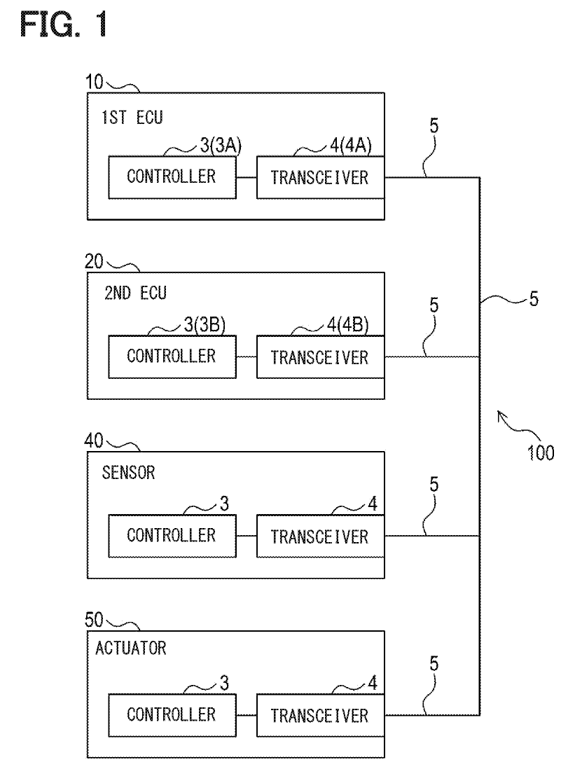

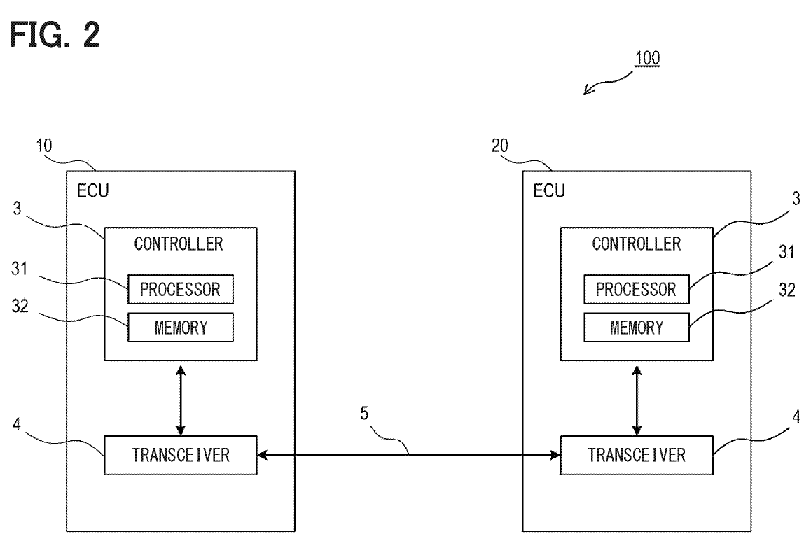

The following will describe a configuration of an on-board communication system 100 according to the present embodiment with reference to FIG. 1 and FIG. 2. The on-board communication system 100 is mounted on a vehicle, and includes an on-board communication line 5 and multiple nodes connected to the on-board communication line 5.

The on-board communication line 5 is configured by an Ethernet signal line compatible with the Ethernet (registered trademark) protocol. Specifically, the on-board communication line 5 is a bus-type Ethernet communication line. The on-board communication line 5 may be an Ethernet communication line defined under 10BASE-T1S. In another embodiment, the on-board communication line 5 is not limited to a bus-type Ethernet communication line, but may be a star-type Ethernet communication line such as 10BASE-T1. Alternatively, the on-board communication line 5 may be a communication line that supports a protocol other than Ethernet. For example, the on-board communication line 5 may be a Controller Area Network (CAN) communication line compatible with the CAN protocol, or a FlexRay communication line compatible with the FlexRay protocol.

The multiple nodes include a first electronic control unit (ECU) 10, a second ECU 20, a sensor 40, and an actuator 50. The first ECU 10 is, for example, a right front door ECU of the vehicle, and controls the locking and unlocking of the right front door and the opening and closing of the power window. The second ECU 20 is, for example, a left front door ECU of the vehicle, and controls the locking and unlocking of the left front door and the opening and closing of the power window. The sensor 40 is, for example, a door sensor that detects whether a door is open or closed. The actuator 50 is, for example, a motor that generates a driving force for opening and closing the power window. In another embodiment, the first ECU 10 may be an Ethernet switch, and may be connected to other ECUs, for example, domain ECUs or zone ECUs which are not shown in the drawing. The multiple nodes may be any combination of ECUs, sensors, actuators, or the like.

The first ECU 10, the second ECU 20, the sensor 40, and the actuator 50 each includes a controller 3 and a transceiver 4. The controller 3 includes a processor 31 and a memory 32. The processor 31 executes various programs stored in the memory 32 to execute various processes. For example, the controller 3 executes a process related to communication via the on-board communication line 5. The memory 32 includes, for example, a random access memory (RAM) and a flash memory. The RAM is used as a working area when the processor 31 executes the process. The flash memory stores programs. The controller 3 corresponds to a control unit and a second communication device of the present disclosure.

The transceiver 4 is an interface implemented in the physical layer of OSI reference model, that is, implemented by hardware logic circuit. Specifically, the transceiver 4 is a physical layer transceiver (specifically PHY) that complies with the Ethernet protocol defined under 10BASE-T1S. The transceiver 4 is directly connected to the on-board communication line 5. The controller 3 is connected to the transceiver 4 by a signal line, and is connected to the on-board communication line 5 through the transceiver 4. The transceiver 4 communicates with other transceivers 4 via the on-board communication line 5. The transceiver 4 transmits various data to the on-board communication line 5 and receives various data from the on-board communication line 5. The transceiver 4 corresponds to a first communication device of the present disclosure.

### 2. Configuration of transceiver

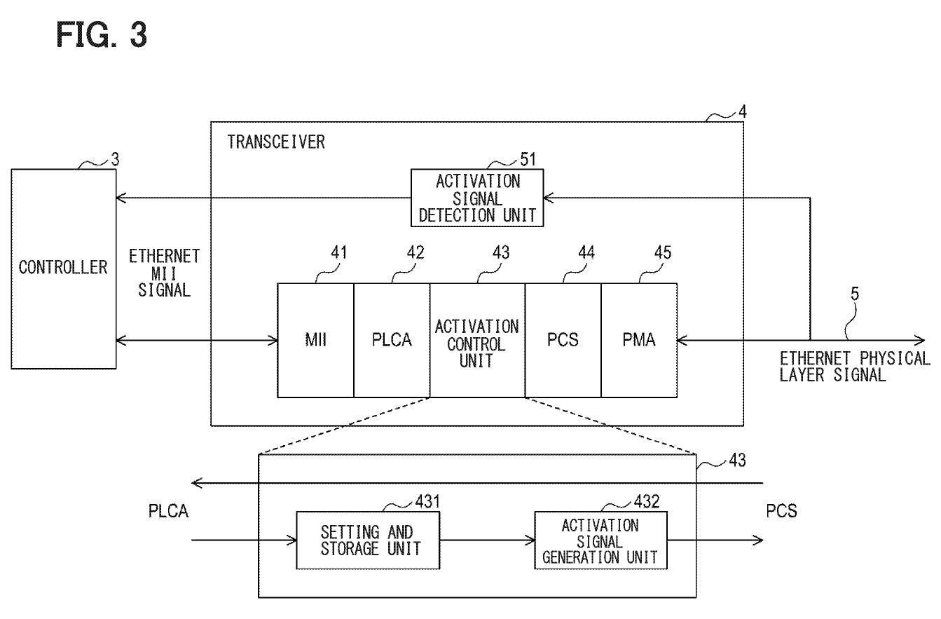

A first example of a functional configuration of the transceiver 4 will be described with reference to FIG. 3. The transceiver 4 includes a Media Independent Interface (MII) 41, a Physical Layer Collision Avoidance (PLCA) 42, an activation control unit 43, a Physical Coding Sublayer (PCS) 44, a Physical Media Attachment (PMA) 45, and an activation signal detection unit 51.

The MII 41, the PLCA 42, the activation control unit 43, the PCS 44, and the PMA 45 are arranged in described order, and the MII 41 is directly connected to the controller 3. Between the controller 3 and the on-board communication line 5, the activation signal detection unit 51 is connected, in parallel, with the MII 41, the PLCA 42, the activation control unit 43, the PCS 44, and the PMA 45.

The activation signal detection unit 51 receives an activation signal, which is transmitted from another node to the on-board communication line 5, and detects identification information included in the activation signal. The activation signal is a signal for switching the transceiver 4 from a sleep state to a normal state, that is, operation state. The sleep state is a state in which partial functions of the transceiver 4 except a predetermined function are deactivated. Specifically, the sleep state is a state in which a function of the activation signal detection unit 51 is in activated state and other functions of the transceiver 4 are in deactivated state. In the normal state, all functions of the transceiver 4 are in activated state. In the sleep state, power is supplied only to the activation signal detection unit 51, and power is not supplied to other functions. Therefore, the sleep state corresponds to a power saving state in which power consumption is lower compared the power consumption in the normal state.

The activation signal is a signal that extends a format of a wake up pulse (WUP) or a wake up request (WUR), which comply with Technical Committee (TC) 10 defined under One-Pair Ether-Net Alliance. The activation signal includes WUP/WUR together with identification information of the node to be activated. The WUP/WUR compatible with TC10 is not assigned with identification information of a target to be activated. Hereinafter, a target to be activated is also referred to as activation target. When a WUP/WUR is transmitted to a one-to-one communication line, only the node to be activated receives the WUP/WUR, and only the node to be activated is activated.

The on-board communication line 5 is a bus-type Ethernet communication line. Therefore, when a WUP/WUR is transmitted to the on-board communication line 5, all nodes connected to the on-board communication line 5 receives the WUP/WUR, and all nodes are activated. Therefore, unnecessary nodes are also activated and consume power, which increases unnecessary power consumption of the communication system.

Therefore, in the on-board communication system 100, the activation signal is provided with identification information of the activation target. The identification information may be one or any combination of Virtual Local Area Network (VLAN) information, Network Management (NM) activation information, and node information.

The VLAN information includes a VLAN ID. The on-board communication line 5 is divided into multiple VLANs, and each node of the on-board communication line 5 belongs to one of the multiple VLANs. For each VLAN, the VLAN ID is correlated to the nodes belonging to the corresponding VLAN. The NM activation information includes a Partial Network Cluster (PNC) used in User Datagram Protocol Network Management (UDPNM) defined by the AUTomotive Open System Architecture (AUTOSAR). AUTOSAR is a global development partnership of the automotive industry. The nodes of the on-board communication line 5 belong to one or more PNCs. The PNC corresponds to a node belonging to each cluster. The node information includes a node ID or a MAC address. A node ID is set for each node of the on-board communication line 5. The MAC address is an identification number assigned to each node device to be different from other nodes.

The activation signal detection unit 51 converts the activation signal into a reception code, and decodes the reception code to generate reception data corresponding to the activation signal. The activation signal is a physical layer signal, that is, an electrical signal. The reception code is bit data. The activation signal detection unit 51 detects the identification information included in the reception data. When the detected identification information corresponds to own node, the transceiver 4 switches from the sleep state to the normal state, that is, activated. When the detected identification information does not correspond to own node, the transceiver 4 maintains the sleep state. That is, all nodes connected to the on-board communication system 100 receive the activation signal. Among all of the nodes, only the node corresponding to the identification information is activated.

When the identification information corresponds to own node, the activation signal detection unit 51 activates a power supply path connected between a power supply circuit to the stopped functional unit. The activation of power supply path activates all functional units of the transceiver 4. When the identification information does not correspond to own node, the activation signal detection unit 51 maintains the sleep state, that is, cuts off the power supply path connected between the power supply circuit and the functional units in deactivated states. This configuration can reduce unnecessary power consumption.

The MII 41 is an interface between the physical layer and Media Access Control (MAC) layer. The MAC is implemented in the data link layer of OSI reference model based on IEEE 802.3, which is the Ethernet standard. The MAC is included in the controller 3. The MII 41 receives transmission data in the Ethernet MII format from the MAC, that is, the controller 3, and transmits the transmission data to the PLCA 42.

The transmission data includes an NM message, identification information of activation target node, activation information, and activation condition. The NM message is an Ethernet frame used in UDPNM defined by AUTOSAR. The NM message is mainly used for state switching related to power saving modes of nodes. The MII 41 transmits the data received from the PLCA 42 to the MAC in the Ethernet MII format.

The PLCA 42 prevents the transmission data, which is transmitted from the transceiver 4 to the on-board communication line 5, from colliding with transmission data, which is transmitted from a transceiver 4 of another node. Since the on-board communication line 5 is a bus network, when multiple transceivers 4 attempt to start communication simultaneously, the transmission data transmitted from the multiple transceivers 4 collide with one another. In order to avoid collision of transmission frames, the PLCA 42 determines the transmission timing assigned to own node, and transmits the transmission timing and transmission data to the activation control unit 43. In addition, the PLCA 42 transmits the reception data received from the activation control unit 43 to the MII 41.

The activation control unit 43 generates an activation signal including identification information corresponding to the activation target node. Specifically, the activation control unit 43 includes a setting and storage unit 431 and an activation signal generation unit 432. The setting and storage unit 431 also corresponds to a setting unit and a storage unit.

The setting and storage unit 431 receives the identification information from the controller 3 via the MII 41 and the PLCA 42, and stores the identification information. Then, the setting and storage unit 431 transmits the identification information to the activation signal generation unit 432 based on the transmission timing determined by the PLCA 42.

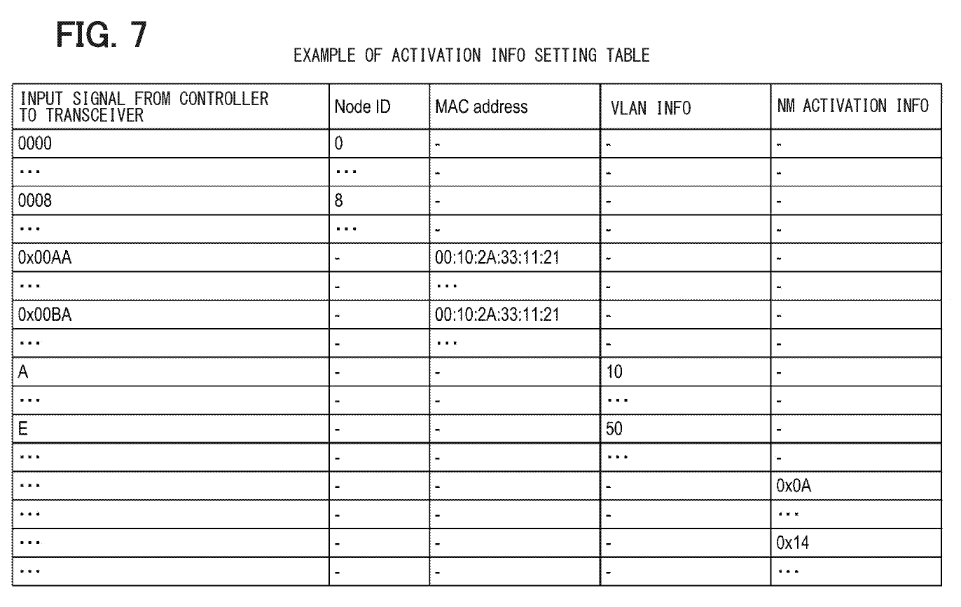

The setting and storage unit 431 receives activation information or activation condition from the controller 3 via the MII 41 and the PLCA, and sets the identification information based on the received activation information or activation condition. The activation information corresponds to one of NM activation information, VLAN information, MAC address, or node ID or combinations of thereof. The setting and storage unit 431 includes an activation information setting table. The activation information setting table indicates a correspondence between (i) an input signal from the controller 3 indicating activation information and (ii) one of NM activation information, VLAN information, MAC address, or node ID or combinations of thereof. FIG. 7 shows an example of the activation information setting table. The activation information setting table can be updated at a proper time via an on-board wireless communication device. The setting and storage unit 431 uses the activation information setting table to set the identification information corresponding to the received activation information.

The activation condition indicates the condition set for the activation target node, for example, "activate the node belonging to group A." The condition is not limited to group A, but may be set as activating a node belonging to another group. The setting and storage unit 431 sets the identification information of the node corresponding to the received activation condition. The setting and storage unit 431 transmits the set identification information to the activation signal generation unit 432. The setting and storage unit 431 may receive only the identification information, only the activation information, or only the activation condition, from the controller 3. Alternatively, the setting and storage unit 431 may receive only two items among the identification information, the activation information, or the activation condition, from the controller. When the setting and storage unit 431 does not receive the activation information from the controller 3, the activation information setting table in the setting and storage unit 431 may be omitted.

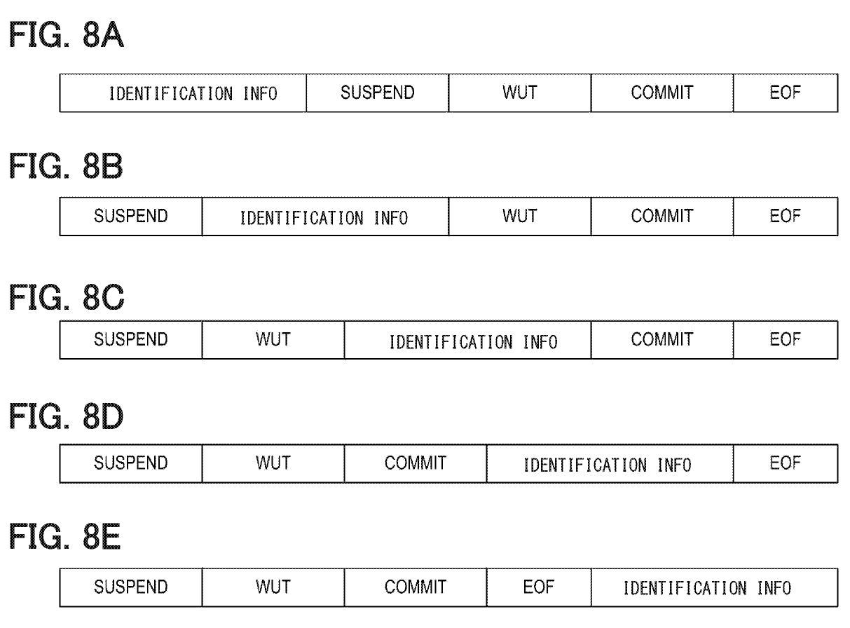

The activation signal generation unit 432 generates an activation signal in which the identification information received from the setting and storage unit 431 is added to a predetermined location of the WUP/WUR. The predetermined location is either a location between two adjacent sections included in the WUP/WUR, or a beginning portion or an end portion of the WUP/WUR. The activation signal generation unit 432 transmits the generated activation signal to the PCS 44 as transmission data. FIG. 8A shows an activation signal in which identification information is added to the beginning portion of the WUP, that is, before SUSPEND. The WUP includes four sections: SUSPEND, Wake-Up Tone (WUT), COMMIT, and End of Frame (EOF). SUSPEND is the first section and consists of six differential Manchester encoded (DME) T symbols. WUT is the second section and consists of a 12-cycle 625 kHz tone that is distinguishable from the DME signal, and WUT can be used as a wake up signal. COMMIT is the third section and consists of 24 to 26 differential Manchester encoded (DME) J symbols. EOF is the fourth section and indicates the end of frame. FIG. 8B shows an activation signal in which identification information is added to the middle portion of WUP, specifically between SUSPEND and WUT. FIG. 8C shows an activation signal in which identification information is added to the middle portion of WUP, specifically between WUT and COMMIT. FIG. 8D shows an activation signal in which identification information is added to the middle portion of WUP, specifically between COMMIT and EOF. FIG. 8E shows an activation signal in which identification information is added to the end portion of WUP, specifically after EOF.

In an example, the location of identification information is set at the beginning portion of WUP/WUR. When the identification information is added to the beginning portion of WUP/WUR, the nodes that are not the activation target can avoid detection of the remaining part of activation signal after detecting the identification information located at the beginning portion. That is, when the identification information is added to the beginning portion of WUP/WUR, the nodes that are not the activation target can detect the minimum amount of information as necessary.

The PCS 44 encodes the transmission data received from the activation control unit 43 to generate a transmission code, and transmits the transmission code to the PMA 45. For example, the PCS 44 performs 4B/3B conversion or scrambling on the transmission data to generate the transmission code. The PCS 44 also decodes the reception code received from the PMA 45 to generate reception data, and transmits the reception data to the activation control unit 43.

The PMA 45 converts the transmission code (i.e., bit data) received from the PCS 44 into a physical layer signal (i.e., an electrical signal) and transmits the physical layer signal to a physical medium for transmission via a Medium Dependent Interface (hereinafter, MDI). The physical medium for transmission corresponds to the Ethernet signal line that constitutes the on-board communication line 5. The PMA 45 also converts a physical layer signal (i.e., an electrical signal) received from a transmission physical medium via the MDI into a reception code (i.e., bit data), and transmits the reception code to the PCS 44. In the present embodiment, the PMA 45 corresponds to a transmission unit of the present disclosure.

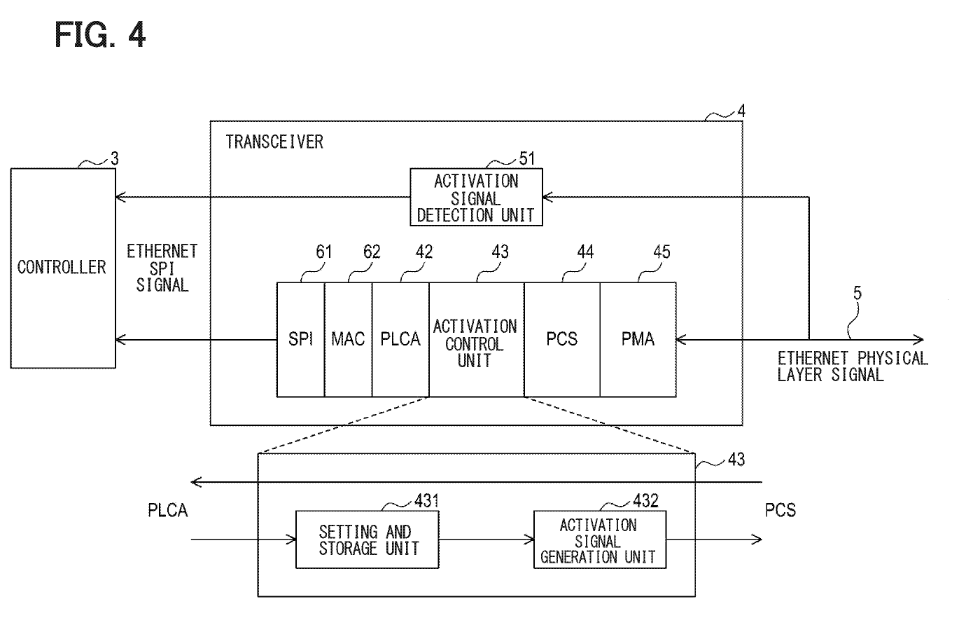

A second example of a functional configuration of the transceiver 4 will be described with reference to FIG. 4. The transceiver 4 according to the second example differs from the transceiver 4 according to the first example in that the transceiver includes a Serial Peripheral Interface (hereinafter, referred to as SPI) 61 and a MAC 62 instead of the MII 41.

MAC is integrated in the transceiver 4 according to the second example. The SPI 61 receives transmission data having the Ethernet SPI format from the controller 3 and transmits the transmission data to the MAC 62. The SPI 61 transmits the data received from the MAC 62 to the controller 3 in the Ethernet SPI format.

The MAC 62 adds control information to the transmission data received from the SPI 61 by assembling the control information to the transmission data as a transmission frame, and transmits the transmission frame to the PLCA 42. The MAC 62 disassembles the received frame received from the PLCA 42 to extract only the reception data, and transmits the extracted reception data to the SPI 61.

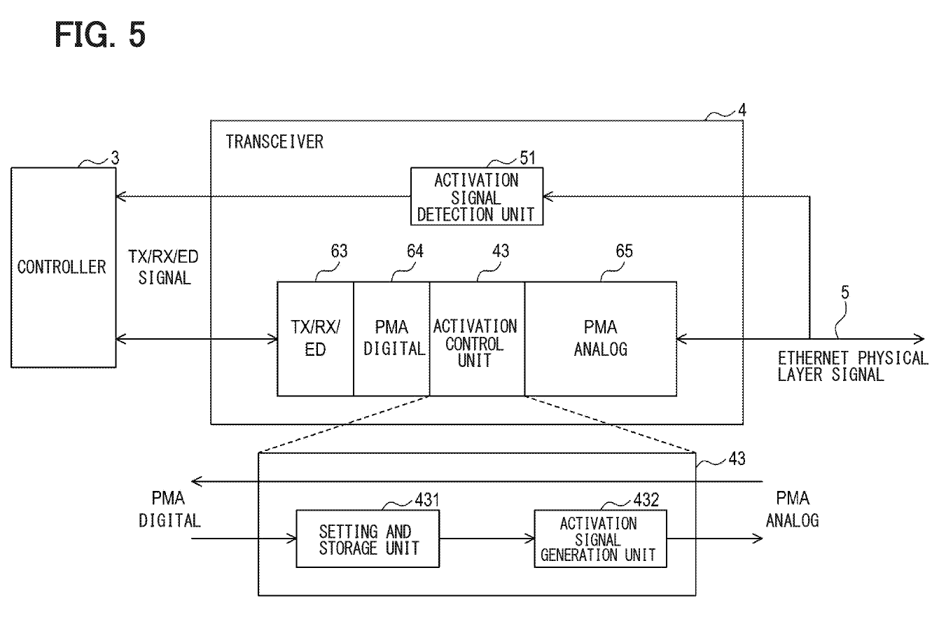

A third example of a functional configuration of the transceiver 4 will be described with reference to FIG. 5. The transceiver 4 according to the third example includes a TX/RX/ED 63 and a PMA digital 64 instead of the MII 41 and the PLCA 42. The transceiver 4 according to the third example includes a PMA analog 65 instead of the PCS 44 and PMA 45. The MAC, PLCA, and PCS are located in the controller 3. The transceiver 4 according to the third example is implemented with only an analog PMA.

The TX/RX/ED 63 receives a physical layer signal from the controller 3 and transmits the physical layer signal to the PMA digital 64. The TX/RX/ED 63 receives a physical layer signal from the PMA digital 64 and transmits the physical layer signal to the controller 3.

The PMA digital 64 converts the physical layer signal received from the TX/RX/ED 63 into a digital signal, and transmits the digital signal to the activation control unit 43. The PMA digital 64 converts the digital signal received from the activation control unit 43 into a physical layer signal, and transmits the physical layer signal to the TX/RX/ED 63.

The PMA analog 65 converts the digital signal transmitted from the activation control unit 43 into a physical layer signal, and transmits the physical layer signal to a physical medium for transmission purpose via the MDI. The PMA analog 65 converts a physical layer signal, which is received from a physical medium for transmission purpose via the MDI, into a reception code, and transmits the reception code to the activation control unit 43. The PMA analog 65 corresponds to a transmission unit of the present disclosure.

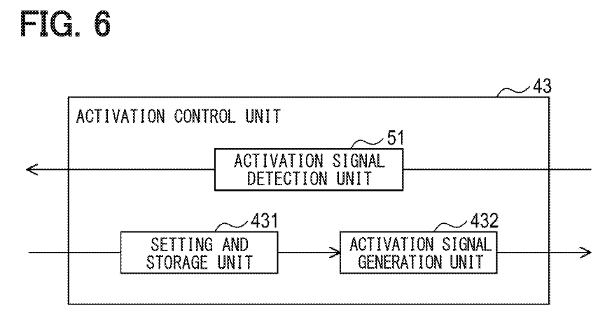

Another example of a functional configuration of the transceiver 4 will be described with reference to FIG. 6. In the transceiver 4 according to another embodiment, the activation signal detection unit 51 is integrated into the activation control unit 43. Between the PLCA 42 and the PCS 44, the activation signal detection unit 51 is arranged in parallel with the setting and storage unit 431 and the activation signal generation unit 432. The PMA 45 receives the activation signal, converts the activation signal into a reception code, and transmits the reception code to the PCS 44. The PCS 44 receives the reception code from the PMA 45 and decodes the reception code to generate reception data corresponding to the activation signal. The PCS 44 transmits the generated reception data to the activation signal detection unit 51. The activation signal detection unit 51 receives the reception data from the PCS 44 and detects the identification information included in the reception data.

Between the PMA digital 64 and the PMA analog 65, the activation signal detection unit 51 may be arranged in parallel with the setting and storage unit 431 and the activation signal generation unit 432. The PMA analog 65 receives the activation signal, converts the activation signal into a reception code, and transmits the reception code to the activation signal detection unit 51. The activation signal detection unit 51 receives the reception code from the PMA analog 65, decodes the reception code, and generates reception data corresponding to the activation signal. The activation signal detection unit 51 detects the identification information included in the generated reception data.

### 3. State Switching

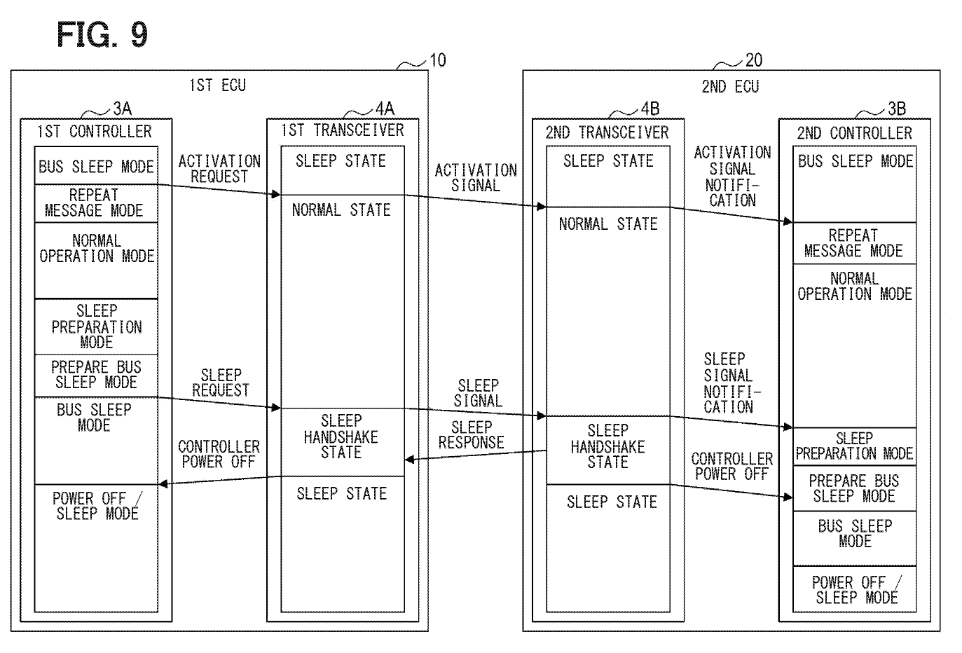

The following will describe, with reference to FIG. 9, state switching of the first ECU 10 and the second ECU 20 when the first ECU 10 is activated by own application and then the first ECU 10 activates the second ECU 20. Suppose a case in which the first ECU 10 is the right front door ECU and the second ECU 20 is the left front door ECU, and the first ECU 10 is activated when the right front door is unlocked, and the first ECU 10 activates the second ECU 20.

The controller 3 of the first ECU 10 (hereinafter referred to as a first controller 3A) and the controller 3 of the second ECU 20 (hereinafter referred to as a second controller 3B) have the following operation modes: bus sleep mode, sleep mode, prepare bus sleep mode, and network mode. The network mode further includes a repeat message mode, a sleep preparation mode, and a normal operation mode.

In sleep mode, most functions except partial function are in deactivated state. The bus sleep mode is an operation mode in which the necessary process is performed to stop the partial function. The prepare bus sleep mode is a standby state, and the sleep is canceled upon receipt of an activation request from an application or an NM message. The repeat message mode is a state in which an NM message is repeatedly transmitted for a certain period of time to notify other nodes of activation. The sleep preparation mode is a state in which message transmission is stopped and preparation is made for switching to the sleep state. In the normal operation mode, all functions are in activated states.

The transceiver 4 of the first ECU 10 (hereinafter referred to as a first transceiver 4A) and the transceiver 4 of the second ECU 20 (hereinafter referred to as a second transceiver 4B) each has, as the operation state, a sleep state, a sleep handshake state, and a normal state. In the sleep state, most functions are stopped, except the partial function. The sleep handshake state is a state in which a notification of switching to the sleep state and a response are exchanged between the first transceiver 4A and the second transceiver 4B. The normal state is a state in which all functions are in activated states.

The first controller 3A is in bus sleep mode because communication is not required while the vehicle is traveling. Upon receiving an activation request from own application, the first controller 3A transmits the activation request to the first transceiver 4A and switches to the repeat message mode. In the repeat message mode, the first controller 3A repeatedly transmits an NM message to the on-board communication line 5 via the first transceiver 4A for a certain period of time, and then switches to the normal operation mode for activation. The NM message corresponds to an activation message of the present disclosure.

Upon receiving an activation request from the first controller 3A, the first transceiver 4A switches from the sleep state to the normal state for activation. The first transceiver 4A generates an activation signal to which the identification information of the second ECU 20 is added, and transmits the activation signal to the on-board communication line 5. The second transceiver 4B receives the activation signal from the on-board communication line 5, and detects the identification information corresponding to own node. Then, the second transceiver 4B switches from the sleep state to the normal state for activation, and notifies the second controller 3B about activation of the second transceiver.

The second controller 3B receives, from the second transceiver 4B, a notification about activation of the second transceiver, and switches from the bus sleep mode to the repeat message mode. After receiving notification about activation of the second transceiver, the second controller 3B switches from the repeat message mode to the normal operation mode for activation in response to receiving the NM message from the first controller 3A.

After the application processing is completed, the first controller 3A switches from the normal operation mode to the sleep preparation mode, and then switches from the sleep preparation mode to the prepare bus sleep mode. The first controller 3A switches from the prepare bus sleep mode to the bus sleep mode and transmits a sleep request to the first transceiver 4A.

Upon receiving the sleep request from the first controller 3A, the first transceiver 4A switches from the normal state to the sleep handshake state and transmits a sleep signal to the second transceiver 4B via the on-board communication line 5.

The second transceiver 4B receives the sleep signal, switches from the normal state to the sleep handshake state, and notifies the second controller 3B about reception of the sleep signal. When the second transceiver 4B is able to switch to the sleep mode, the second transceiver transmits a sleep response to the first transceiver 4A via the on-board communication line 5.

Upon receiving notification from the second transceiver 4B about reception of the sleep signal, the second controller 3B switches from the normal operation mode to the sleep preparation mode, and then switches from the sleep preparation mode to the prepare bus sleep mode.

Upon receiving the sleep response, the first transceiver 4A requests the first controller 3A to turn off power, and switches from the sleep handshake state to the sleep state. Upon receiving the power-off request, the first controller 3A turns off the power and switches from the bus sleep mode to the sleep mode.

After transmitting the sleep response, the second transceiver 4B requests the second controller 3B to turn off power, and switches from the sleep handshake state to the sleep state. The second controller 3B receives the power-off request and switches from the prepare bus sleep mode to the bus sleep mode. Then, the second controller 3B turns off power and switches from the bus sleep mode to the sleep mode.

### 4. Effects

According to the present embodiment described above, the following effects are achieved.

(1) The transceiver 4 receives an activation signal transmitted from another node to the on-board communication line 5. The transceiver 4 then detects the identification information included in the activation signal and is activated in response to the identification information corresponds to own node. Since the nodes other than the activation target are connected to the on-board communication line 5, the nodes other than the activation target receive the activation signal, but are not activated because the identification information does not correspond to node. Therefore, the transceiver 4 can be individually activated in response to an activation request transmitted from another node connected to the on-board communication line 5.

(2) The transceiver 4 generates an activation signal including identification information corresponding to the activation target node, and transmits the activation signal to the on-board communication line 5. This configuration allows the transceiver 4 to individually activate a specific node among the multiple nodes.

(3) The transceiver 4 can generate an activation signal in which the activation target node is specified, using the identification information received from the controller 3.

(4) The transceiver 4 can identify the activation target node based on the activation information or activation condition received from the controller 3, and generate an activation signal in which the activation target node is identified.

(5) The transceiver 4 can generate an activation signal that includes identification information at a proper location.

(6) When the identification information is added to the beginning portion of the activation signal, nodes other than the activation target node can detect that the identification information does not correspond to own node and can maintain the sleep state without detecting further information following the identification information in the activation signal.

(7) The controller 3 can be activated when the transceiver 4 directly connected to the controller 3 is activated and an NM message is received via the on-board communication line 5.

### Other Embodiments

Although the embodiments of the present disclosure have been described above, the present disclosure is not limited to the above embodiments, and various modifications can be made.

Multiple functions of one element in the above embodiments may be implemented by multiple elements, or one function of one element may be implemented by multiple elements. Further, multiple functions of multiple elements may be implemented by one element, or one function implemented by multiple elements may be implemented by one element. In each of the above embodiments, a part of the configuration may be properly omitted. At least a part of the configuration of the above embodiment may be added to or substituted for the configuration of another embodiment.

What is claimed is:

1. A transceiver, which is included in a node connected to an on-board communication line as one of multiple nodes, the transceiver comprising
at least one circuit including an activation signal detection unit configured to detect identification information of an activation signal, which is transmitted by another one of the multiple nodes to the on-board communication line,
wherein
each of the multiple nodes is configured to transmit, to the on-board communication line, the activation signal that includes the identification information for identifying own node, and
the transceiver is configured to be activated when the identification information detected by the activation signal detection unit corresponds to own node.

2. The transceiver according to claim 1, wherein
the at least one circuit further includes:
an activation signal generation unit configured to generate the activation signal to include the identification information for identifying an activation target, which is one of the multiple nodes; and
a transmission unit configured to transmit, to the on-board communication line, the activation signal generated by the activation signal generation unit.

3. The transceiver according to claim 2, wherein
the at least one circuit further includes a storage unit configured to store the identification information received from a controller,
the controller is configured to execute a process related to communication with the multiple nodes by controlling the transceiver, and
the storage unit is further configured to pass the identification information to the activation signal generation unit.

4. The transceiver according to claim 2, wherein
the at least one circuit further includes a setting unit configured to set the identification information based on activation information or an activation condition received from a controller,
the controller is configured to execute a process related to communication with the multiple nodes connected to the on-board communication line by controlling the transceiver, and
the setting unit is further configured to pass the set identification information to the activation signal generation unit.

5. The transceiver according to claim 3, wherein
the activation signal detection unit, the activation signal generation unit, and the storage unit are integrated with one another.

6. The transceiver according to claim 4, wherein
the activation signal detection unit, the activation signal generation unit, and the setting unit are integrated with one another.

7. The transceiver according to claim 1, wherein
the identification information is added to a beginning potion, a middle portion, or an end portion of the activation signal.

8. The transceiver according to claim 7, wherein
the identification information is added to the beginning portion of the activation signal.

9. A communication system comprising
a first communication device and a second communication device, which are connected to an on-board ethernet communication line as multiple nodes,
wherein
the first communication device includes an activation signal detection unit configured to detect identification information of an activation signal received from the on-board ethernet communication line,
each of the multiple nodes is configured to transmit, to the on-board ethernet communication line, the activation signal that includes the identification information for identifying own node,
the first communication device is configured to be activated when the detected identification information corresponds to the first communication device and then transmit a notification indicating activation of the first communication device to the second communication device, and
the second communication device is configured to be activated when an activation message is received from the on-board ethernet communication line after receiving, from the first communication device, the notification indicating activation of the first communication device.

10. The communication system according to claim 9, wherein
the first communication device further includes:
an activation signal generation unit configured to generate the activation signal by assigning identification information corresponding to an activation target, which is one of the multiple nodes; and
a transmission unit configured to transmit, to the on-board ethernet communication line, the activation signal generated by the activation signal generation unit.

11. The communication system according to claim 9, wherein
the identification information is added to a beginning potion, a middle portion, or an end portion of the activation signal.

12. The communication system according to claim 11, wherein
the identification information is added to the beginning portion of the activation signal.

13. A method for activating a transceiver connected to an on-board communication line, the method comprising:
receiving an activation signal from the on-board communication line, the activation signal having identification information for identifying one of multiple nodes connected to the on-board communication line;
detecting the identification information of the received activation signal; and
activating the transceiver in response to the detected identification information corresponding to own node.
